(19) United States
(12) Patent Application Publication
(10) Pub. No.: US 2006/0016977 A1
(43) Pub. Date: Jan. 26, 2006

(54) Time-of-flight analyzer

(75) Inventor: Eizo Kawato, Kyoto-fu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Kyoto (JP)

(21) Appl. No.: 11/183,757

(22) Filed: Jul. 19, 2005

(30) Foreign Application Priority Data
Jul. 20, 2004 (JP) 2004-211558

(51) Int. Cl. H01J 49/40

(52) U.S. Cl. 250/287

(57) ABSTRACT

In order to provide a time of flight analyzer in which the timings of the ion generation and the ion signal recorder are synchronized, and the peak center position can be determined at high accuracy with fewer measurements, the time of flight analyzer of the present invention includes an ion source and an ion signal recorder working on an internal clock, wherein the ion signal recorder generates a trigger signal in synchronism with the internal clock in order to generate ions in the ion source. Since the timing of accelerating ions in the ion source and the timing of digital sampling and recording of the ion signal, which is detected in the ion detector, in the ion signal recorder are synchronized, the timing error occurred in conventional methods can be suppressed.

The present invention relates to a time-of-flight (TOF) analyzer in which ions are generated in an ion source and the time-of-flight of the ions is measured in an ion detector. The TOF analyzer of the present invention can be used in a Matrix-Assisted Laser Desorption/Ionization (MALDI) type TOF mass spectrometer, or in an ion trap type TOF mass spectrometer in which an ion trap is used as the ion source.

### BACKGROUND OF THE INVENTION

In a TOF mass spectrometers, ions are generated in an ion source, that is, the ions are accelerated to a predetermined speed and ejected to a flight space, and the ions are detected by an ion detector after flying in the flight space of a certain length. The time-of-flight, i.e. the length of time from the time point when the ions are ejected from the ion source to the time point when the ions are detected by the ion detector, is recorded by an ion signal recorder, and the mass to charge ratios of the ions are determined using the recorded time-of-flight of the ions.

In “Mass Analysis using the Matrix-Assisted Laser Desorption/Ionization Method”, Koichi Tanaka, Bunseki, vol. 4(1996), pp. 253-261, the Matrix-Assisted Laser Desorption/Ionization Time-Of-Flight Mass Spectrometer (MALDI TOF-MS) is disclosed, in which the mass analysis of ions are performed by accelerating ions generated by irradiating a laser beam, and measuring the time-of-flight of the ions to the time point when the ions arrive at an ion detector. In “The design and performance of an ion trap storage-reflectron time-of-flight mass spectrometer”, Benjamin M. Chien, Steven M. Michael and David M. Lubman, International Journal of Mass Spectrometry and Ion Processes, vol. 131(1994), pp. 149-179, an ion trap TOF mass spectrometer is disclosed, in which the mass analysis of ions are performed by accelerating ions trapped in an ion trap, and measuring the time-of-flight of the ions to the time point when the ions arrive at an ion detector. There are various other TOF mass spectrometers, such as one in which secondary ions generated by irradiating ions are used for an ion source.

In a conventional ion signal recorder of a TOF analyzer, a time to digital converter (TDC) was mostly used. In a TDC, a counter is made to count at a constant clock rate, and the time difference between a start signal and a stop signal is measured from the difference of the counter value at the time point when the counter receives a start signal and the counter value at the time point when it receives a stop signal.

In a TOF mass spectrometer using a TDC as shown in FIG. 1, a trigger signal is sent from the controller to the ion source, which makes ions fly, and at the same time, the trigger signal is sent to the TDC as a start signal. When an ion arrives at the ion detector, a pulse signal is generated in the ion detector, and is sent to the TDC as a stop signal. The TDC records the difference in the counter values between at the time when the start signal arrives and at the time when the stop signal arrives, and send it to the data processing unit. In an alternative method, the counter is normally reset to zero, starts counting at the time when the start signal arrives at the TDC, and stops counting at the time when the stop signal arrives, and the value of the counter is recorded.

Since the clock frequency of the TDC is known, the time-of-flight is easily calculated by multiplying the counter value by a cycle time of the clock of the counter. From the time-of-flight and the information of the kinetic energy of ions and the flight distance, the mass to charge ratio of the ions are calculated. Since, however, an ion reflector is provided in order to compensate for the variation in the initial kinetic energy of ions, and ions are decelerated and accelerated in the ion reflector, the calculation of the time-of-flight of the ions is not easy if the accuracy of the time-of-flight is intended to be improved.

In that case, a simple way of calculating the mass to charge ratio of an ion is to use the fact that the time-of-flight of an ion is proportional to the square root of its mass if its kinetic energy and the flight distance are the same irrespective of the mass. First, the time-of-flight of an ion having known mass to charge ratio is measured. Then the time-of-flight of an ion having unknown mass to charge ratio is measured. The measured time-of-flight of unknown ion is divided by that of the known ion, the quotient is multiplied by itself, and the result is multiplied by the mass to charge ratio of the known ion, whereby the mass to charge ratio of the unknown ion is obtained.

In actual analyzers, ions of different mass to charge ratio may have different starting positions and different initial kinetic energies and/or different efficiencies of acceleration in the ion source, and the exact proportionality is difficult to obtain. Thus, the time-of-flight of plural kinds of ions having known mass to charge ratios are measured beforehand, and the error in the time-of-flight which depends on the mass is corrected based on the data.

In a TDC of early times, only the time difference between the start signal and the first stop signal was measured. In this case, only the pulse that first arrived at the ion detector could be measured in one measurement. Thus, in actual devices, a multi-stop type TDC is used which can output plural counter values in response to plural stop pulses corresponding to respective time-of-flights.

Advantages of using a TDC in an ion signal recorder are that the measurement circuit is simple, and the measurement cycle can be made short, which allows a high-speed measurement. But, even when a multi-stop type TDC is used, the number of pulses that can be measured after one start signal is limited. Thus it is necessary to decrease the signal intensity, and decrease the number of ion pulses in a measurement. In order to suppress the variation in the number of counts and improve the S/N ratio of the measurement in that case, it is necessary to make many measurements. When plural ions arrive at the ion detector within a short period, it is impossible to have enough time for switching counters to detect latter-arriving ions. In this case, the latter-arriving ions cannot be detected, i.e. a dead-time exists.

Regarding such a shortcoming associated with the TDC, an analog to digital converter (ADC) is widely used in recent TOF mass spectrometers. Owing to the progress in the digital data processing technologies, an ADC can provide the time precision of almost the same level as a TDC.

A TOF mass spectrometer using an ADC is described referring to FIG. 2. The method of using an ADC works in a similar principle to a digital storage oscilloscope (DSO). The ADC is triggered by the start signal, and an analog signal whose amplitude is proportional to the number of ions arriving at the ion detector is sent from the ion detector to the ADC, where the analog signal is converted to a digital signal. The digital signals are recorded as a time series data and shown on a screen by a data processing unit. In the DSO, the data are shown with time as the abscissa, while, in the TOF mass spectrometer, the data are shown with the mass to charge ratio.

A TDC requires many measurements to make a histogram of the arrival time of ions, while, with an ADC, a mass spectrum with a high S/N ratio can be collected with rather fewer measurements because a signal intensity proportional to the number of arriving ions is obtained.

In many mass spectrometers, the typical time-of-flight ranges from several μsec to tens of μsec, depending on the mass to charge ratio to be measured and on the size of the mass spectrometer. If the mass resolution of 10000 is required, the accuracy of time measurement needs to be 1/20000 of the time-of-flight or less, which means that the time-of-flight needs to be measured with the accuracy of about 1 ns. This requires the internal clock frequency of the ADC in the ion signal recorder to be 1 GHz or higher.

Using an ADC with such a high clock frequency is not so difficult in the current DSO technology. When, however, the clock frequency is raised, for example, from 1 GHz to 2 GHz, the amount of data generated is doubled for the same time-of-flight range. Suppose that the time-of-flight is measured for 100 μsec, the amount of data generated in a measurement doubles from 100000 to 200000. If the clock frequency is raised to 4 GHz, the amount of data further doubles. The data are not only recorded in the data processing unit, but also accumulated for averaging, and shown on the screen with conversion from time to mass-to-charge-ratio in real time. Thus the clock frequency cannot be increased limitlessly, but should be decided at a reasonable value regarding the data processing speed of the corresponding amount of data. Thus in normal TOF mass spectrometers using an ADC, the clock frequency used in the ion signal recorder is set to about 1 GHz.

On the other hand, the demand for higher accuracy in determining the mass to charge ratio is pronounced. In the measurements of large molecules such as DNA or peptides (or components of proteins), the accuracy of the mass to charge ratio is critical in determining the molecular structure. Suppose the accuracy in the mass to charge ratio is required to be 10 ppm, the measurement accuracy of the time-of-flight needs to be 5 ppm. For example, for ions having the time-of-flight of 40 μsec, the measurement accuracy is required to be 200 psec.

When an ADC is used at 1 GHz clock frequency, the cycle time of the digital conversion is 1 nsec. In this case, a peak of an ion signal is formed, as shown in FIG. 3, by a polygonal line with data points of 1 nsec intervals, and the center of the peak is calculated from the data points. For example, respective time point is weighted with the signal intensity to obtain the center of the peak by a center of gravity method. Owing to such a method, the time-of-flight can be calculated at higher accuracy than the ADC sampling intervals.

In general, the amount of ions, the initial position, the initial kinetic energy and other factors vary from measurement to measurement, and the shape of a peak differs accordingly. Thus, plural measurements are performed, and the data of respective measurements are accumulated to obtain an averaged spectrum. This yields a true and reproducible center of the peak.

When, however, a sample is not supplied constantly, an adequate number of measurements is impossible, and the accuracy of the center of a peak is not adequately high. For example, in a high performance liquid chromatograph (LC) mass spectrometer, a sample is separated by the LC, and the separated sample enters the ion source, and mass analysis is performed. So the components of the sample measured by the mass spectrometer gradually change with time. In order to complete measurements enough for a molecular structural analysis of a specific component of a sample while the component is being introduced into the ion source, the center of a peak should be determined at high accuracy with fewer measurements.

In conventional TOF mass spectrometers, the controller sends a trigger signal to the ion source to start acceleration of ions, and, at the same time, sends a start signal to the ion signal recorder to start counting in the TDC, or start sampling in the ADC. At this time, since the start signal or the trigger signal is not synchronized with the clock of the TDC or the ADC, the TDC counter or the ADC data sampling actually starts at the time when the start signal or the trigger signal has detected on an edge of the internal clock in the ion signal recorder. Thus, when 1 GHz clock is used in the ion signal recorder, the time point at which the ions are accelerated and the time point at which the data sampling starts in the ion signal recorder differ by 1 nsec at most.

The difference of timing between ion generation and start sampling decreases as the clock frequency is increased. But, as explained before, the amount of data to be processed increases as the clock frequency is increased. It is possible to use a high frequency clock to detect the start signal at high precision and decrease the difference of timing, and divide the high frequency clock to obtain an adequately slow TDC clock or ADC clock. But the difference of timing cannot be zero as long as the clock is not synchronized. Rather, inevitable noises occur due to an increase in the clock frequency, and the additional frequency division circuit boosts the cost and increases heat production.

### SUMMARY OF THE INVENTION

Since, as described above, in conventional TOF mass spectrometers, the timing of start acceleration of ions in the ion source and the clock of the ion signal recorder are not synchronized, the timing to start data sampling includes a timing error of one clock cycle at most. Especially in the case of fewer measurements, it is the major cause of deteriorating the accuracy of the center of a peak or peaks.

In view of the above-described problems, an object of the present invention is to provide a time-of-flight analyzer in which the timings of the ion generation and start sampling in the ion signal recorder are adequately adjusted, and the center of a peak is determined at high accuracy with fewer measurements.

According to the present invention, a time-of-flight analyzer comprises:

an ion source for generating ions with an externally given trigger signal; and

an ion signal recorder, working on an internal clock and generating a trigger signal in synchronism with the internal clock in order to trigger the ion source for ion generation.

In the above-described time-of-flight analyzer of the present invention, the ion signal recorder may use an analog to digital converter (ADC).

Or, alternatively, in the time-of-flight analyzer of the present invention, the ion signal recorder may use a time to digital converter (TDC).

The working principle of the time-of-flight analyzer of the present invention is explained with reference to the time-of-flight mass spectrometer of FIG. 4, which uses an ADC as an ion signal recorder. When a measurement is started, a start signal is sent from the controller to an ion signal recorder (ADC) to make it start the digital conversion of the analog signal coming from the ion detector, and recording. At this time, the ion signal recorder (ADC) generates a trigger signal and sends it to the ion source for informing the start of data sampling. On receiving the trigger signal, the ion source starts acceleration of ions and ejects them into the flight space. When the ions arrive at the ion detector, an analog signal whose amplitude is proportional to the number of ions arrived is sent from the ion detector to the ion signal recorder (ADC), which records the signal including a peak or peaks. The data thus obtained is sent from the ion signal recorder (ADC) to the data processing unit, where a mass spectrum is constructed with the mass to charge ratio as the abscissa, the peak position(s) is calculated, and other data processing is performed.

The start signal given externally from the controller and the analog to digital conversion of the signal are not synchronized. But the analog to digital conversion and the trigger signal to the ion source are both synchronized with the internal clock because signals are processed in synchronism with the internal clock. So, the timing to start acceleration of ions in the ion source and the timing to start sampling and recording of the ion signal are synchronized. This alleviates the above-described problem of the conventional time-of-flight analyzer by eliminating a timing error of one clock cycle at most.

Thus, according to the time-of-flight analyzer of the present invention, the trigger signal for representing a start of data sampling in the ion signal recorder is generated in synchronism with the internal clock of the ion signal recorder, and the trigger signal is used to start acceleration of ions in the ion source. This suppresses a timing error in the conventional time-of-flight analyzer originating from asynchronous ion generation and sampling. Since the deviation of the central position of a peak in a mass spectrum becomes rather small, the mass to charge ratio of an ion can be determined at high accuracy with fewer measurements. This is especially advantageous in the case where a composition of the sample is such as in the case of an LC-MS. The molecular structure of each component of the sample can be determined within a rather short period while the component is introduced into the ion source.

### BRIEF DESCRIPTION OF THE DRAWINGS

FIG. 1 is a schematic diagram of a TOF mass spectrometer using a TDC.

FIG. 2 is a schematic diagram of a TOF mass spectrometer using an ADC.

FIG. 3 is a part of a mass spectrum including an ion peak obtained by an ADC working on 1 GHz internal clock.

FIG. 4 is a schematic diagram of a TOF mass spectrometer according to the present invention using an ADC.

FIG. 5 is a schematic diagram of a high performance liquid chromatograph ion trap time-of-flight mass spectrometer (LC-IT-TOFMS) embodying the present invention.

FIG. 6 is a graph of deviation of the peak positions of a mass spectrum measured by an LC-IT-TOFMS embodying the present invention.

FIG. 7 is the same graph measured by a conventional LC-IT-TOFMS.

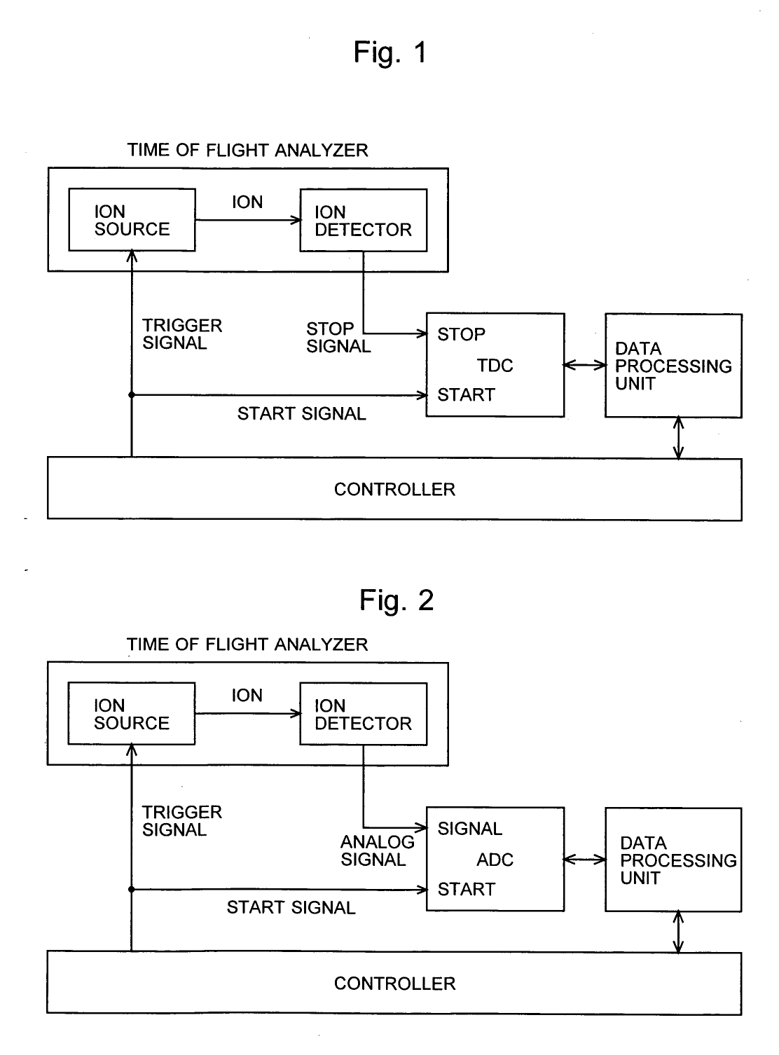

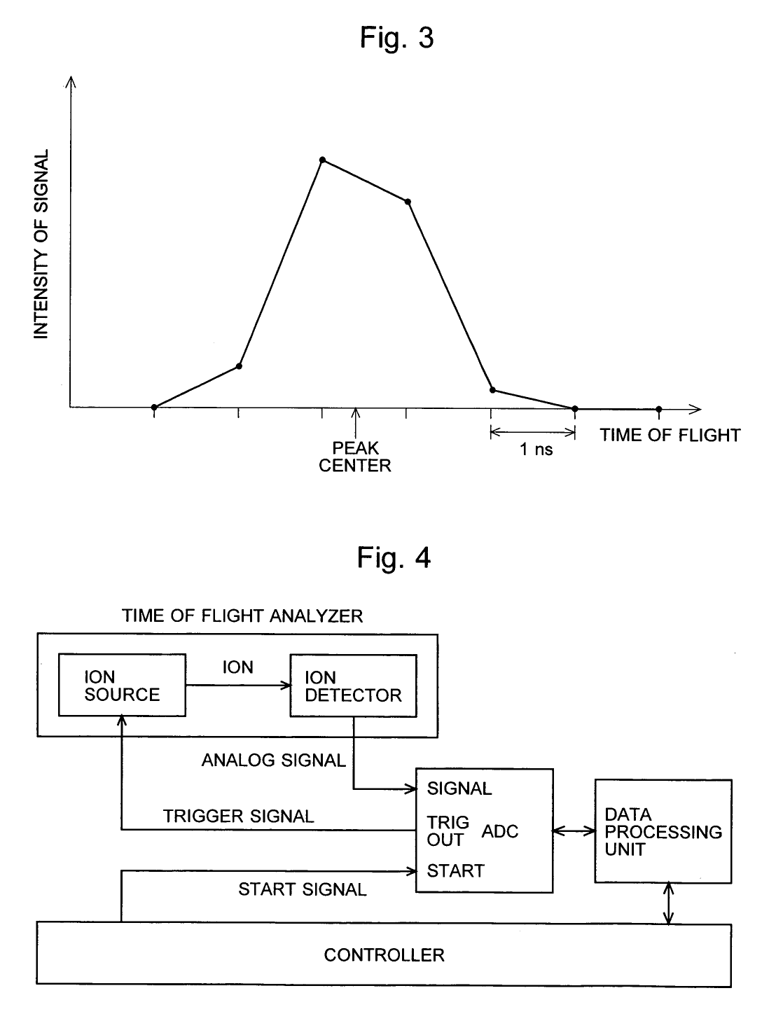

### DETAILED DESCRIPTION OF A PREFERRED EMBODIMENT

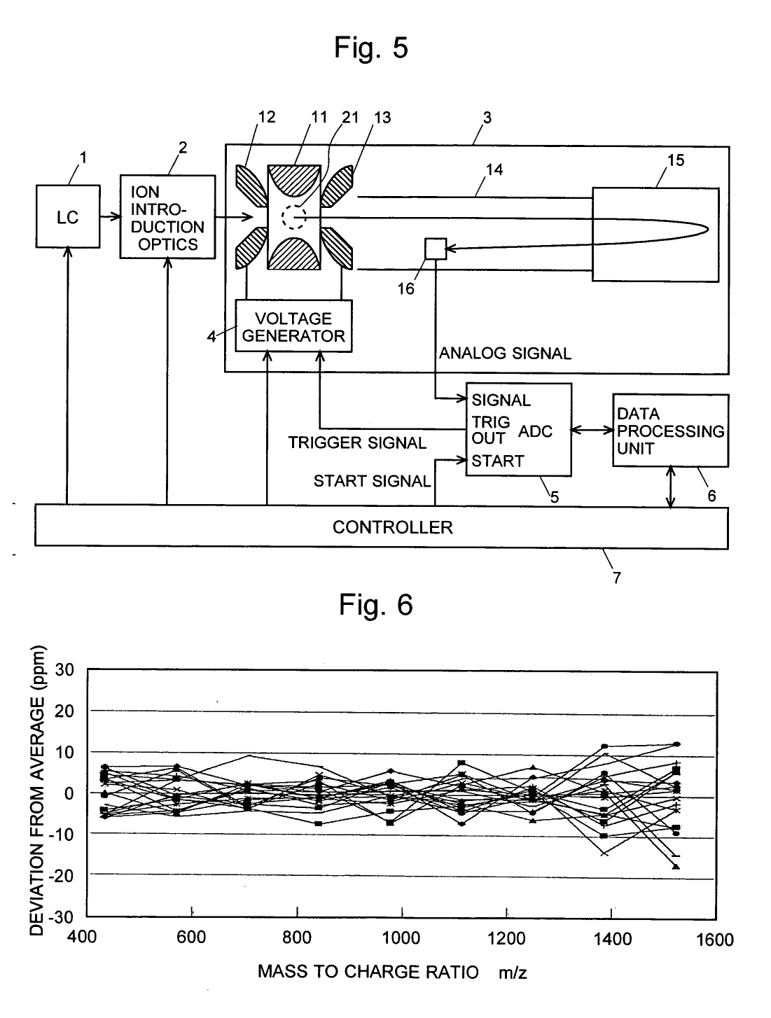

A high performance liquid chromatograph ion trap time-of-flight mass spectrometer (LC-IT-TOFMS) embodying the present invention is described. FIG. 5 is a schematic diagram of the main part of the LC-IT-TOFMS.

The high performance liquid chromatograph (LC) 1 is an analyzer where a liquid sample is injected, and its components are ejected at different timings according to their properties. In the LC-IT-TOFMS of the present embodiment, the LC 1 is used as a preparatory device of the mass spectrometer. The components of the liquid sample ejected from the LC 1 in time-series are ionized in an ion introduction optics 2, and the ions are injected into the vacuum space. The ion introduction optics 2 includes an ionizing probe and an ion guide. Ionizing probes such as an electrospray ionizing probe or an atmospheric pressure chemical ionizing probe are used to ionize the component, wherein the liquid component is broken into tiny droplets, the droplets are then dried, and are given electric charges, so that ions of the component are generated. The ions thus generated are transferred to the ion guide in a vacuum by a differential pumping system. In the ion guide, ions are trapped and concentrated by a multi-pole electric field. The ions are sent to the ion trap of the TOF analyzer 3 at an appropriate timing. The TOF analyzer 3 includes an ion source, a flight space 14, an ion reflector 15, and an ion detector 16.

The ion trap is used for the ion source in the present embodiment, where the ion trap is composed of a ring electrode 11 and a pair of end cap electrodes 12, 13 opposing each other with the ring electrode 11 therebetween. When a radio frequency voltage is applied to the ring electrode 11, an ion trapping space 21 is formed and ions are trapped in it owing to the quadrupole electric field generated within the space surrounded by the ring electrode 11 and the two cap electrodes 12 and 13. In the ion trapping space 21, ions are selected and dissociated, i.e. a preparatory analysis is performed before the ions are analyzed with the TOF analyzer. The electrodes 11, 12 and 13 of the ion trap are connected to an ion trap voltage generator 4, which applies appropriate voltages at appropriate steps of a mass analysis. The ion trap voltage generator 4, in response to a trigger signal, accelerates ions trapped in the ion trapping space 21 and eject them to a flight space 14, whereby the ion trap functions as the ion source of the TOF analyzer 3. For example, in the case of measuring cations, the voltage of the ring electrode 11 is set to 0 V, the entrance end cap electrode 12 to +5370 V, and the exit end cap electrode 13 to −10000 V. Owing to the voltage configuration, the cations in the ion trapping space 21 are accelerated and ejected to the flight space 14.

The flight space 14 is set at the same voltage as the exit end cap electrode 13, −10000 V in the above-described example, whereby no electric field is applied to the ions flying in it, and the ions fly at a constant speed.

At the end of the flight space 14 is provided an ion reflector 15, on which an appropriate voltage is applied to compensate for the variation in the initial position and initial kinetic energy of ions starting from the ion trap. When ions enter the ion reflector 15, they are decelerated by the electric field settled inside the ion reflector, and then are accelerated toward the ion detector 16.

After being reflected by the ion reflector 15, the ions again fly in the flight space 14 at a constant speed, and arrive at the ion detector 16. An MCP (Micro Channel Plate) detector is used as the ion detector 16, in which case an analog pulse signal proportional to the number of ions arrived at every moment is generated.

Though not shown in the drawing, respective voltage generators are connected to the flight space 14, the ion reflector 15 and the ion detector 16 and appropriate voltages are applied to them depending on the polarity of ions to be measured.

The analog pulse signals generated by the ion detector 16 are sent to the SIGNAL input terminal of an ion signal recorder (which is called a transient recorder) 5. The ion signal recorder 5 works with the internal clock of 2 GHz, and starts sampling when a start signal arrives. When it starts sampling, the 2 GHz internal clock is divided by two to generate a 1 GHz sampling clock, whereby an analog signal is converted to digital data and recorded at every 1 nsec.

The data sampled in the ion signal recorder 5 are then sent to a data processing unit 6 at appropriate timings. The data processing unit 6 processes the data in various manners including data representation with the mass to charge ratio as an abscissa, and determination of the accurate positions of the peaks.

A controller 7 controls the timing and the voltages applied to the above described components at every phase of an analysis.

In order that ions are ejected from the ion source, i.e. the ion trap, to start a time-of-flight analysis, a start signal is sent from the controller 7 to the ion signal recorder 5. On receiving the start signal, the ion signal recorder 5 detects arrival of the start signal in synchronism with the internal clock of 2 GHz, generates a sampling clock of 1 GHz, starts data sampling, and outputs a trigger signal to the ion trap voltage generator 4. Since the trigger signal and the 1 GHz sampling clock are generated from the same 2 GHz internal clock, they are always synchronized.

On receiving the trigger signal from the ion signal recorder 5, the ion trap voltage generator 4 applies ion acceleration voltages as described above to the electrodes of the ion trap. Since, on the route from input of the trigger signal to the application of the ion accelerating voltages in the ion trap voltage generator 4, all elements are connected with analog lines, and no process working on the clock is included, ions are accelerated in synchronism with the trigger signal.

This means that the generation of ions based on the trigger signal and that the start of sampling the analog signal from the ion detector 16 in the ion signal recorder 5 are perfectly synchronized, and they are independent of the timing between the start signal sent from the controller 7 to the ion signal recorder 5 and the internal clock of the ion signal recorder 5.

FIG. 6 shows the deviation of the peak positions of ions of various mass to charge ratios measured many times using an LC-IT-TOFMS of the above embodiment. Plural peaks appear in the mass spectrum obtained in one measurement, and the center of every peak is calculated. Forty such measurements are repeated, and the deviation of each peak position from its average position is plotted against the mass to charge ratio to obtain the graph of FIG. 6. The breadth of deviations is within about ±5 ppm at every mass to charge ratio, though it deteriorates at some mass to charge ratios due to low S/N ratios where the ion signal intensity is small. Since, in ordinary analysis, the center of a peak position is calculated from the average spectrum of several measurements, its deviation decreases in inverse proportion to the square root of the number of measurements. For example, when the center of a peak position is calculated from four measurements, the deviation breadth decreases to about ±2.5 ppm.

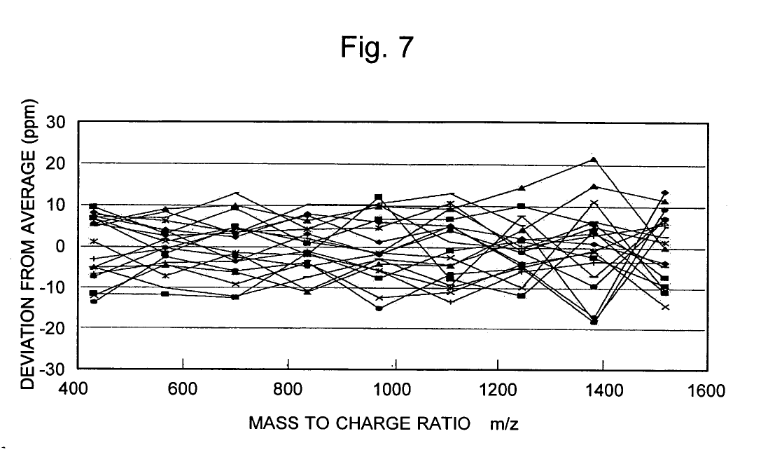

FIG. 7 is the same graph as obtained in the conventional LC-IT-TOFMS, where the trigger signal from the ion signal recorder 5 to the ion trap voltage generator 4 is disconnected, and the start signal from the controller 7 is directly given to the ion trap voltage generator 4 as the trigger signal in comparison with the LC-IT-TOFMS of the above embodiment. The conditions are the same as in the case of FIG. 6. Since, in this case, a timing error of one internal-clock cycle, 500 psec at largest, is involved, the deviation is as large as ±10 ppm, or twice as in the above case.

The above comparison experiments clearly show that the peaks of a mass spectrum can be determined more precisely, specifically about twice as much, than before by the present invention. This means that, when a measurement of the same precision is sought, the number of measurements can be reduced by a quarter. This is especially advantageous when a complex structural analysis is conducted in which measurements of various precursor ions are required.

There is still a possibility of reducing the breadth of the ±5 ppm deviation of FIG. 6 by stabilizing the jitter from the trigger signal, the fluctuation of the ion accelerating high voltages and the fluctuation of the voltages applied to the flight space 14, the ion reflector 15 and the ion detector 16.

In the conventional method, however, the primary cause is the timing error due to the internal clock, 500 psec when 2 GHz clock is used, of the ion signal recorder 5 which is not in synchronism with the ion source. There is no way to improve it within the range of the conventional method.

Although only some exemplary embodiments of the present invention have been described in detail above, those skilled in the art will readily appreciate that many modifications are possible without materially departing from the present invention. Accordingly, all such modifications are intended to be included within the scope of the present invention.

What is claimed is:

1. A time-of-flight analyzer comprising:
an ion source for generating ions with an externally given trigger signal; and
an ion signal recorder, working on an internal clock and generating a trigger signal in synchronism with the internal clock in order to trigger the ion source for ion generation.

2. The time-of-flight analyzer according to claim 1, wherein the ion signal recorder uses an analog to digital converter (ADC).

3. The time-of-flight analyzer according to claim 1, wherein the ion signal recorder uses a time to digital converter (TDC).

4. A method of controlling a time-of-flight analyzer comprising:
an ion source for generating ions with an externally given trigger signal;
an ion signal recorder working on an internal clock,
wherein the ion signal recorder triggers the ion source for ion generation by sending a trigger signal in synchronism with the internal clock.

5. The method of controlling a time-of-flight analyzer according to claim 4, wherein the ion signal recorder uses an analog to digital converter (ADC).

6. The method of controlling a time-of-flight analyzer according to claim 4, wherein the ion signal recorder uses a time to digital converter (TDC).
